(19) United States
(12) Patent Application Publication
(10) Pub. No.: US 2013/0009402 A1
(43) Pub. Date: Jan. 10, 2013

(54) WAVE-ENERGY CONVERTER

(76) Inventor: Arthur R. Williams, Holden, MA (US)

(21) Appl. No.: 13/635,614

(22) PCT Filed: Mar. 16, 2011
(86) PCT No.: PCT/US11/28679

§ 371 Date: Sep. 17, 2012

(30) Foreign Application Priority Data
Mar. 18, 2010 (US) 61315158
Oct. 21, 2010 (US) 61405287

(51) Int. Cl. F03B 13/18; F03B 13/14

(52) U.S. Cl. 290/53; 60/499

(57) ABSTRACT

Wave-Energy-Conversion (WEC) systems harness the water motion internal to waves propagating on large bodies of water to produce more readily usable forms of power, such as electricity. The water motion internal to a wave is oscillatory, and power is extracted from it by submerging structures that oscillate with the water, but more slowly. The power extracted from a wave is the product of the speed of the structure and the associated drag force on the structure. Because the structure moves more slowly than the water, increasing its speed reduces its speed relative to the water and with it the drag force. This tradeoff is optimized by maximizing the drag force for a given relative speed. The disclosed WEC systems exploit, in a variety of ways, the greater drag force provided by WEC structures of concave shape.

### CROSS REFERENCE TO RELATED APPLICATIONS

This application claims benefit of the priority of U.S. Provisional Patent Application No. 61/315,158 filed Mar. 18, 2010 entitled SEA ANCHOR WAVE ENERGY CONVERTER, and U.S. Provisional Patent Application No. 61/405,287 filed Oct. 21, 2010 entitled PELTONSURGEWEC.

### STATEMENT REGARDING FEDERALLY SPONSORED RESEARCH OR DEVELOPMENT

—Not applicable—

### FIELD OF THE INVENTION

The present application relates generally to renewable energy, and more particularly to the generation of power by extracting energy from water waves.

### BACKGROUND OF THE INVENTION

The present application concerns the capture and conversion of solar energy that has been converted via surface wind into water waves. More specifically, the present application concerns the capture of both the heave (vertical) and surge (horizontal) water particle movement within waves for conversion into other forms of power, such as electricity.

We are concerned here with the oscillatory water particle motion internal to propagating water waves. The spatial and time scales of waves distinguish them from other ocean energy resources such as tides and currents.

The objective of wave-energy capture and conversion is not unlike that of harnessing a draft animal or locomotive, but, there are two important differences. First, wave motion is oscillatory, and second, fluids are more difficult to “grab hold of” and “hang onto”. A practical way by which we can “grab hold” of a fluid is to exploit the drag force on a submerged structure. Such drag force depends strongly on the shape of the submerged structure. Two structures designed for the drag they produce are the parachute and the sea anchor. FIG. 1 compares the drag produced by two simple shapes. Tabulated in FIG. 1 are the drag coefficients for the two shapes, a hollow sphere and its corresponding two-dimensional shape, a circular half pipe.

The drag force on an immersed structure is proportional to the area that faces the oncoming fluid flow and to the square of the speed of that flow relative to the immersed structure. The arrows in the right-hand column of FIG. 1 indicate the direction of the fluid flow relative to the structural shape shown in the left-hand column. For shapes like those considered in FIG. 1, a convex shape becomes concave when the direction of the flow impinging on the structure is reversed. In summary, FIG. 1 shows that concave structures provide greater drag.

For certain types of wave energy converters, fluid drag on an immersed structure produces the forces needed to capture and convert wave energy into a more useful form. For these types of devices, in order to collect wave energy, the structure itself must move, and there are two limiting cases that serve to establish the range of this required motion. First, if the immersed structure does not move at all, the structure can reflect energy, but it cannot absorb energy. The stationary structure limit is called the sea-wall limit. The other limiting case is when the immersed structure moves in perfect harmony with the wave motion, i.e., no relative motion of the fluid and the structure. Here we have motion, but no force, and, thus, no energy is captured. This limit is called the sea-weed limit; i.e., the immersed structure sloshes back and forth like sea weed. The useful range of the speed of the immersed structure is between zero and the local speed of the fluid.

The physics of drag is momentum transfer, and is illustrated in FIG. 2 by reflection by a receding reflector. FIG. 2 shows what happens when a particle approaches a reflecting barrier with relative speed V.

In FIG. 2, the upper row shows the particle before the collision, and the lower row shows the particle after the collision. We see that the outcome of the collision with the reflecting barrier depends on the speed with which the barrier is receding.

If the barrier is stationary (the sea-wall limit), the particle is reflected with the same speed. If the barrier recedes at the same velocity as the incoming particle (the sea-weed limit), then no collision occurs, and the momentum of the particle is unchanged. If, however, the barrier recedes at half the speed of the incoming particle, then the speed of the particle relative to that of the barrier is the same before and after the collision, but the direction is reversed. The particle is left with no speed at all. This is the physics underlying the Pelton turbine. To extract energy from fluid motion, it is known to devise a structure that can reverse the relative motion of the water and the immersed structure while moving the structure in the same direction as the water, but at nominally half its speed. Concave structures have a tendency to guide the fluid along a path that reverses the relative motion of the fluid and the immersed structure.

Since drag is proportional to the area of the immersed structure exposed to the wave front, the area of the WEC structure is a parameter that can affect system performance. The edges of the structure around which the water can flow (escape) is typically minimized. Further, the ratio of perimeter to area can affect system performance more than area alone. As with the more familiar surface-to-volume ratio, the perimeter-to-area ratio decreases as system size increases.

Two known WEC structures used to capture wave energy are the paddle and the buoy. Paddles are used primarily to capture the energy in surge (horizontal) water particle motion. They operate by oscillating back and forth in reaction to surge motion, and the paddle normally pivots about an axis parallel to the wave front. U.S. Pat. Pub. No. 2006/0150626 describes a surge-type WEC whose paddle is completely submerged. U.S. Pat. No. 7,834,474 describes a surge-type WEC whose paddle extends to and through the water surface.

Buoys are used primarily to capture the energy in heave (vertical) water particle motion. U.S. Pat. Pub. No. 2005/0121915 is representative of this group. U.S. Pat. No. 4,208,877 describes a submerged cylindrical buoy moored diagonally so as to capture energy from both surge and heave motion.

Most wave-energy converters (WECs) in operation today are convex or planar, that is, not concave.

WECs can be classified according to their geometry, that is, points, lines, and surfaces. WECs possessing a point geometry are called point absorbers, and they are typically approximately spherical. The sphere has a convex shape. An example of a substantially spherical point absorber is described in U.S. Pat. Pub. No. 2005/0121915. In WECs possessing a point geometry, all three spatial dimensions are similar in magnitude.

A second class of WEC's is characterized by structures in which two of the spatial dimensions are similar in magnitude, while the third is significantly larger. One such structure is a cylinder, which is also convex. Such WECs can be oriented with the long dimension horizontal and parallel to the wave crests as in the device described by U.S. Pat. No. 4,208,877, or vertically as with the BioWave™ system described by U.S. Pat. Pub. No. 2010/0156106.

In a third class of WECs, one spatial dimension is smaller than the other two. Included in this third class of WECs is the planar WaveRoller™ surge-type WEC described by U.S. Pat. Pub. No. 2006/0150626. Another substantially planar, surge-type WEC is the Oyster™ WEC described by U.S. Pat. No. 7,834,474.

Japanese Pat. No. 57165675 describes a sea-anchor-like device designed to capture tidal currents.

The Pelton water turbine can extract energy from the momentum of a moving fluid. The Pelton turbine comprises a number of cups mounted on a rotating wheel. The wheel rotates so that the concave cups recede from an incident fluid stream. The Pelton turbine does not operate when submerged.

One challenge provided by earlier work is the exploitation of concavity in maximizing fluid drag on the WEC device.

In the known systems discussed above, only the device described in Japanese Pat. No. 57165675 utilizes a concave structure. Because this device is designed to capture the energy of tidal flows, the frequency with which the device reverses direction is lower than that required of WECs. The use in this device of a single surface whose curvature reverses with each oscillation can render the device impractical in the higher-frequency wave-energy-capture context.

Other challenges addressed by the present application include device protection in violent weather, tracking of tidal depth variations, tracking of changes in wave direction, and the capture of heave (vertical) energy by a surge-type WEC.

### BRIEF SUMMARY OF THE INVENTION

The present application discloses several components that can be organized into groups, specifically, those relating to the geometry of the WEC device, and those relating to the mooring of the WEC device through a power-take-off (PTO) subsystem and energy storage. Geometry deals with structures that guide water around a corner so as to maximize the momentum transferred from the water to the WEC structure that results in the force on the WEC structure which, coupled with the motion of the WEC structure, produces power. WEC structures can be classified according their geometry, that is, point, line, and surface. All three geometrical types are amenable to concave implementations.

Mooring deals with the exploitation of the force-motion product captured from the waves, and with the cost benefits flowing from a specific type of mooring.

Mooring options also affect deployment issues. WEC structures moored to floating platforms can readily track tidal depth variations as well as variations in wave direction. Platform mooring also facilitates maintenance and offers a way of protecting the WEC system in violent weather.

The power captured from waves is typically irregular, and can be stored and/or smoothed to be made more useful. One mode of energy storage, hydrogen production by electrolysis, can eliminate such irregularity, and can simplify the transmission of captured wave power to shore and beyond.

In accordance with one aspect, a wave-energy-conversion (WEC) device includes a WEC structure having a substantially stationary base, and at least one concave surface. The WEC structure is at least partially immersed in a body of water, and oscillates with the local water motion comprising wave action near the surface of the body of water. The amplitude of the oscillation of the WEC structure is reduced relative to that of the wave action by a restraining force provided by a power-takeoff (PTO) subsystem that combines the restraining force with the motion of the WEC structure relative to the substantially stationary base to produce power in a convenient form. The concave surface of the WEC structure faces and opposes the local water motion, thereby tending to reverse the local water motion.

Other features, functions, and aspects of the invention will be evident from the Drawings and/or the Detailed Description of the Invention that follow.

### BRIEF DESCRIPTION OF THE SEVERAL VIEWS OF THE DRAWINGS

The invention will be more fully understood with reference to the following Detailed Description of the Invention in conjunction with the drawings of which:

FIG. 1 is a table illustrating the effect of shape convexity/concavity on fluid drag;

FIG. 2 is a diagram illustrating reflection from a receding barrier;

FIG. 3a is a diagram illustrating a spherical (convex) buoy used to capture the heave (vertical) component of wave motion;

FIG. 3b is a diagram illustrating a concave version of buoy shown in FIG. 3a;

FIG. 4a is a diagram illustrating a point- or line-like WEC structure comprising a triangular cluster of three individually concave structures;

FIG. 4b is a diagram illustrating a cross section of the triangular cluster shown in FIG. 4a showing the concavity and relative orientation of the component structures;

FIG. 5a is a diagram illustrating a vertical cross section of concave paddle;

FIG. 5b is a diagram illustrating a horizontal cross section of concave paddle;

FIGS. 6a, 6b, and 6c are diagrams illustrating momentum exchange with the paddles of surge-type WECs;

FIG. 7a is a diagram illustrating a concave line-like WEC structure;

FIG. 7b is a diagram illustrating an increase in buoy area with a keel;

FIG. 7c is a diagram illustrating a three-point mooring;

FIG. 7d is a diagram illustrating a buoy with multiple keels;

FIG. 7e is a diagram illustrating a hinge-attached keel;

FIG. 7f is a diagram illustrating a buoy with a paneled keel;

FIG. 8a is a diagram illustrating a floating pulley, power-take-off (PTO) subsystem;

FIG. 8b is a diagram illustrating a pulley on a piston, PTO subsystem;

FIG. 8c is a diagram illustrating a pulley on a structure, PTO subsystem;

FIG. 9a is a diagram illustrating a concave, surge-type WEC system employing a hinged-based, PTO subsystem;

FIG. 9b is a diagram illustrating a concave, surge-type WEC system employing a cable-based, PTO subsystem; and

FIG. 10 is a diagram illustrating a platform-moored, concave buoy with a keel.

### DETAILED DESCRIPTION OF THE INVENTION

The disclosures of U.S. Provisional Patent Application No. 61/315,158 filed Mar. 18, 2010 entitled SEA ANCHOR WAVE ENERGY CONVERTER, and U.S. Provisional Patent Application No. 61/405,287 filed Oct. 21, 2010 entitled PELTONSURGEWEC, are hereby incorporated herein by reference in their entirety.

We recall from the summary above that the present application involves issues of geometry and mooring. We consider issues of geometry first.

Wave-energy-conversion (WEC) devices can be grouped according to their geometry: point, line, or surface. Point systems are characterized by comparable spatial extent in all three dimensions. The sphere is a point structure, but it is also convex.

Line-like WEC structures are characterized by one spatial dimension being larger than the other two. The cylinder is the prototype and it too is convex. The long dimension of a line-like WEC structure can be aligned in three possible directions, of which we focus on two: perpendicular to the water surface, and parallel to both the water surface and the wave crests.

Surface-like WEC structures are characterized by one spatial dimension that is smaller than the other two. A planar sheet is the prototype.

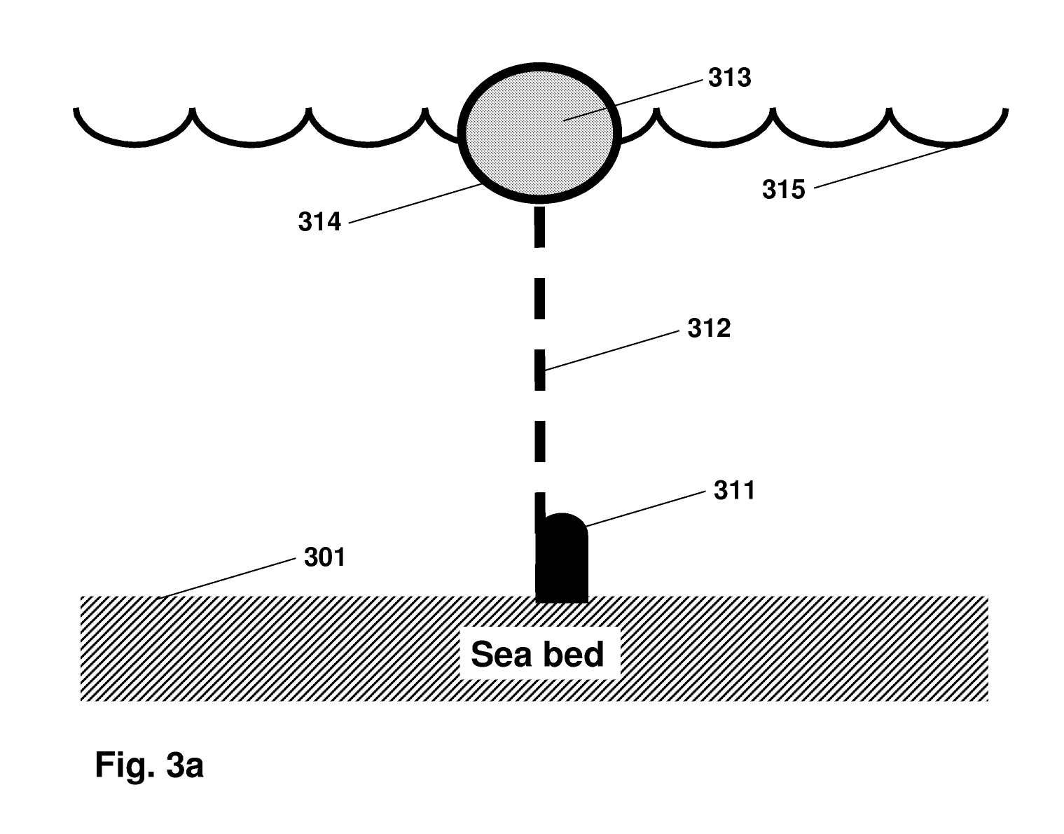

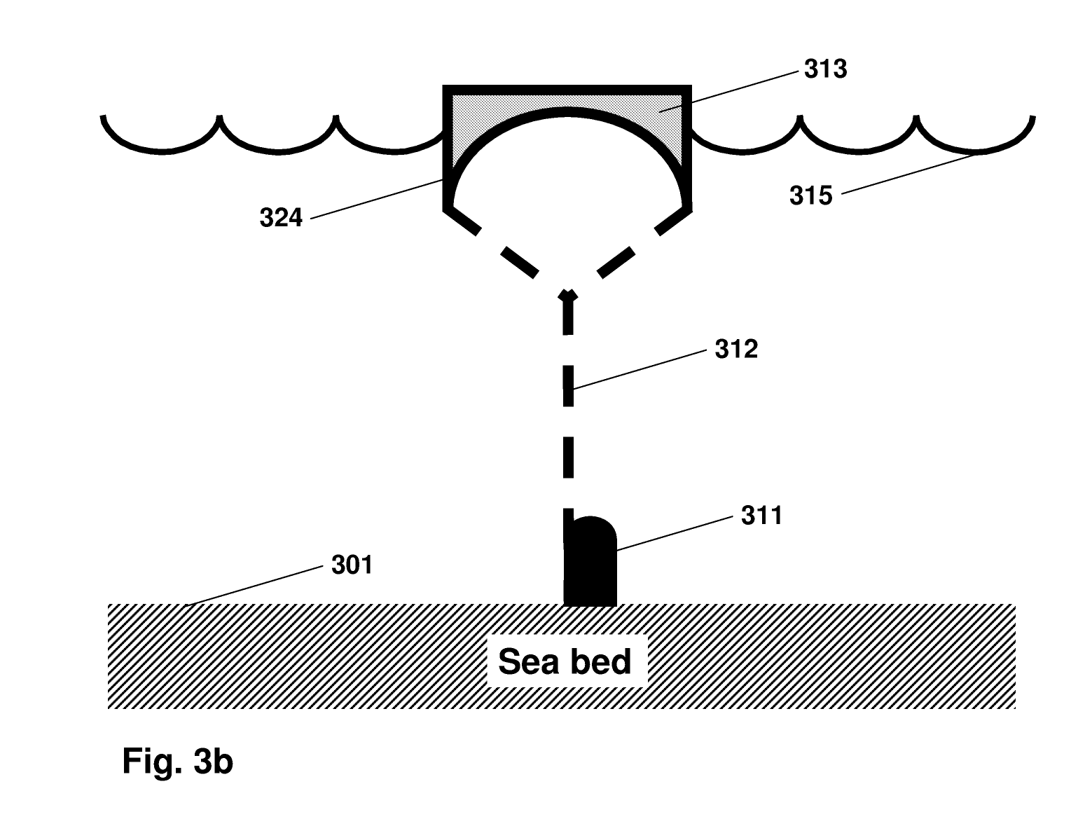

FIG. 3a illustrates a spherical WEC structure. Such WECs are called point absorbers. FIG. 3a shows the WEC structure 314, a spherical buoy, moored to the sea bed 301 by a generic power-takeoff (PTO) subsystem. The PTO subsystem can take any suitable form. We use a cable-based power-takeoff (PTO) subsystem as an illustration. Alternatives include rack-and-pinion systems, and linear electric generators. In a cable-based PTO subsystem, one end of a cable 312 is attached to the buoy while the other end is wrapped around a drum axially attached to an electric generator. When the wave action causes the buoy 314 to rise, the wrapped drum converts the resulting cable motion into rotary motion of the drum, thereby generating electricity. The drum and generator appear as unit 311 in FIG. 3a. We refer to the cable, drum, and generator as a cable-based PTO subsystem. One such cable-based PTO subsystem is described, for example, by U.S. Pat. No. 4,208,877. In FIG. 3b, we have replaced the convex sphere 314 of FIG. 3a by a concave WEC structure 324.

Note that diagrams like FIGS. 3a and 3b describe point-like systems having rotational symmetry about the cable 312, or line-like systems in which the buoys 314 and 324 extend into the plane of the diagram. When describing line-like systems, the buoys 314 and 324, the sea bed 301, and the water surface 315 all extend into the plane of the diagram. By contrast, the PTO subsystem 311 and 312 is discrete, but may be repeated as required for reasons of strength, capacity, etc. The interior of the buoys 313 is a low density material, such as air, foam, or any other suitable low density material.

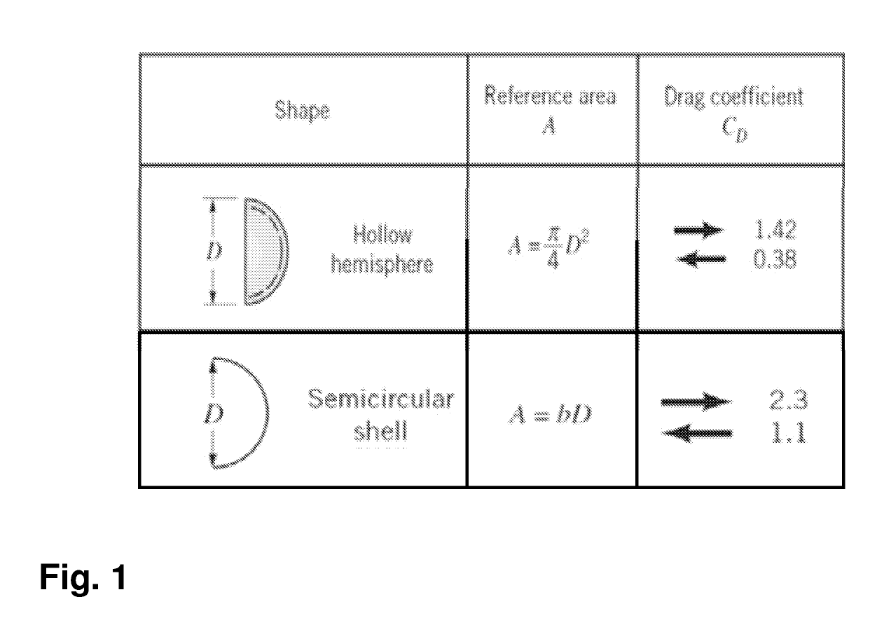

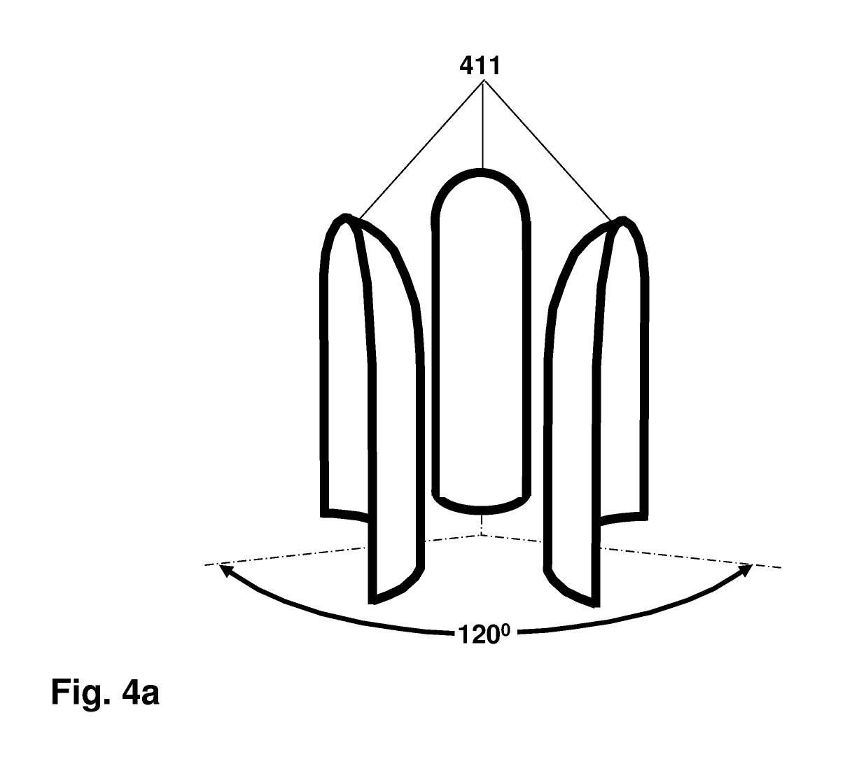

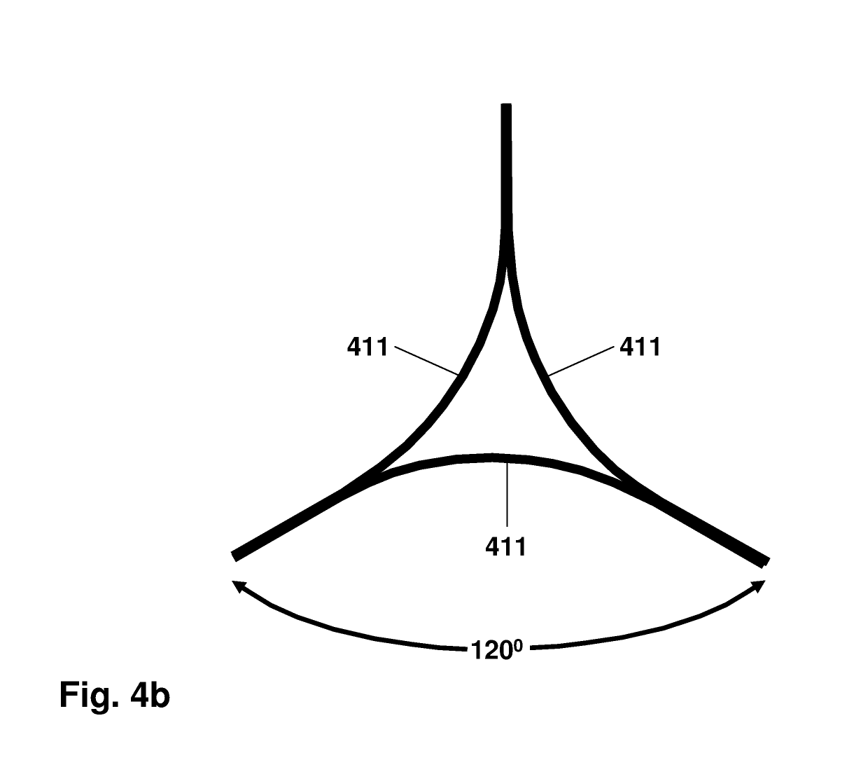

FIG. 4a shows a triangular cluster of three individually concave substructures 411, each of which can be thought of as the half-pipe shown in the bottom row of FIG. 1 terminated by half the hollow hemisphere shown in the middle row of FIG. 1. Such a structure could replace, for example, the fingers of the WEC structure described in U.S. Pat. Pub. No. 2010/0156106. The concave substructures 411 are shown pulled apart for clarity in FIG. 4a. Notice that WEC structures like that shown in FIG. 4a take us from point-like WEC structures to line-like WEC structures as the length of the straight, half-pipe portion of the structure is increased.

The WEC structure in FIG. 4a is well adapted to situations in which the propagation direction of the waves we are trying to harness varies significantly. FIG. 4b is a horizontal cross section of the WEC structure shown in FIG. 4a; it shows how the hollow ellipsoids of FIG. 4a can be wedged into the 120-degree sectors of the WEC structure. The length of the long axis of the hollow ellipsoids is arbitrary. In this way, the point-like WEC structures, such as that shown in FIG. 4b evolve into the line-like structures as we increase the length of the long axis. The constant feature in this evolution is the tendency of the hollow ellipsoid to reverse a fluid flow impinging on it.

The WEC structure of FIG. 4b may be moored by three cable-based PTO subsystems forming a mooring tripod connecting the WEC structure to a triangle on the sea bed. Each of the three cable-based PTO subsystems forming the tripod is attached to one of the three concave surfaces 411 so that the energy in waves approaching from any direction is captured by these parachute-like subsystems. The third class of WEC structures, those possessing a surface-like geometry, are characterized by a smaller spatial extent in one of its three dimensions. So-called “SurgeWEC systems”, WECs deployed in relatively shallow water to capture the horizontal (surge) component of wave action, like the WaveRoller™ and the Oyster™ systems with their wave-facing paddles (surface) illustrate this geometry.

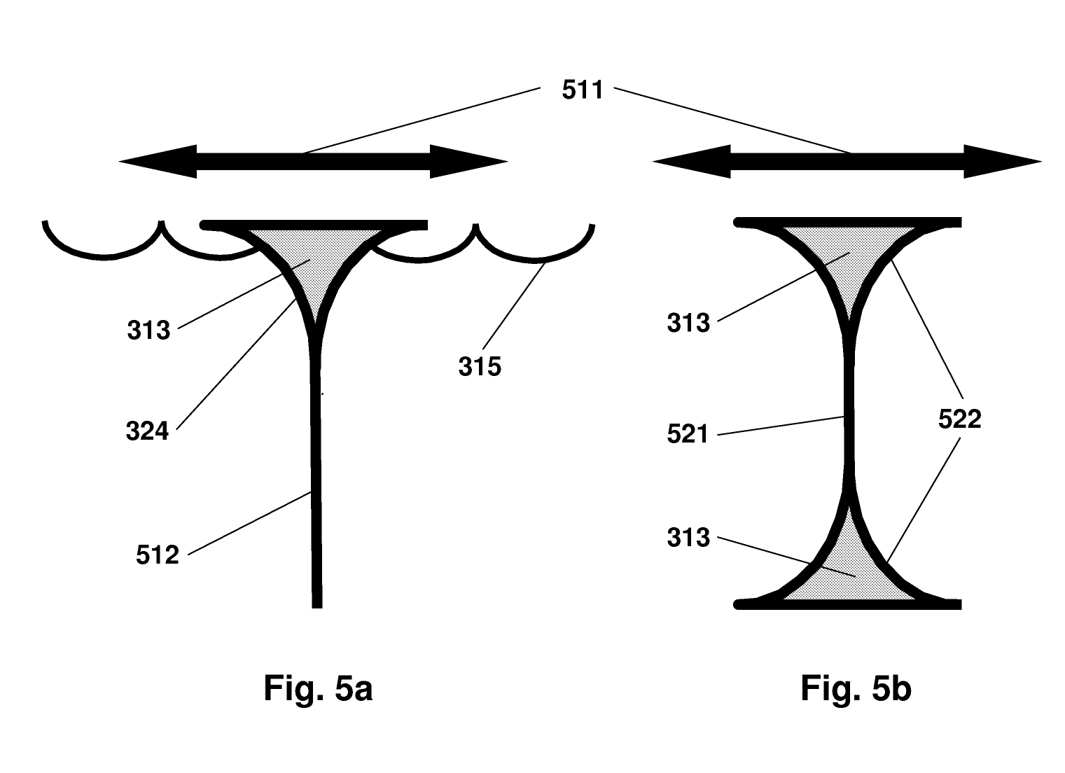

Surfaces terminate at edges, and edges provide escape routes for the fluid motion we are trying to harness. Escape is reduced by making the wave-facing surfaces of the surface-like surgeWEC structure concave. FIGS. 5a and 5b show how the top 314 (horizontal) and side 522 (vertical) edges of a surgeWEC paddle are rendered concave.

FIG. 5a is a vertical cross section of a concave surgeWEC paddle, and FIG. 5b is a horizontal cross section. The curved surfaces 314 and 522 serve a double purpose. They reduce the escape of the fluid flow around and edge, and they cause a reversal of the flow direction.

FIG. 5a also introduces the keel 512, a surface-like WEC structure component attached to the concave buoy 324. The keel serves to increase the surface area exposed to the wave action. While the buoy used to illustrate the keel in FIG. 5a is concave, a keel can be attached to convex WEC structures as well. The position of the combined WEC structure relative to the water surface 315 is controlled by the buoyancy of the structure 324, which is, in turn, controlled by the volume of the buoy 324 and the low-density material 313 contained within the buoy 324. The arrows 511 indicate the oscillatory motion of both the water and the paddle. The double-sided surfaces 512 and 521 of the surface-like WEC structure are the “working” surfaces of the WEC structure. Note that a keel transforms a horizontal line-like WEC structure 324 into a surface-like WEC structure. The keel 512 shown in FIG. 5a allows horizontal line-like WEC structures to evolve into surface-like structures. Both the buoy 324 and the keel 512 extend into the plane of the diagram; the length of the buoy 324 and keel 512 are determined by factors such as capacity and structural strength.

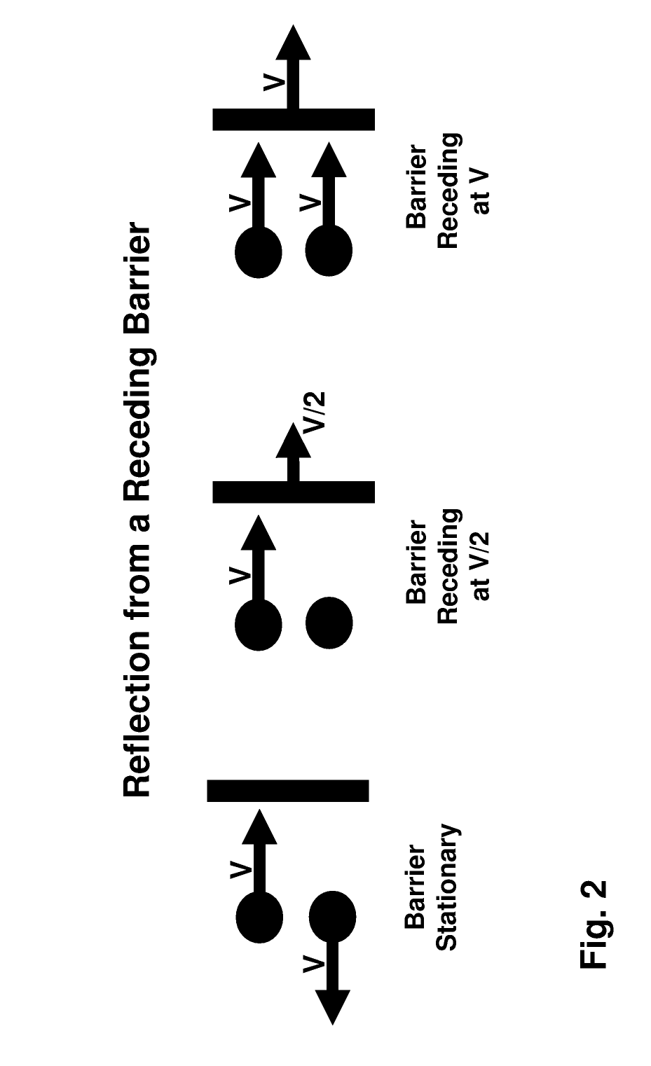

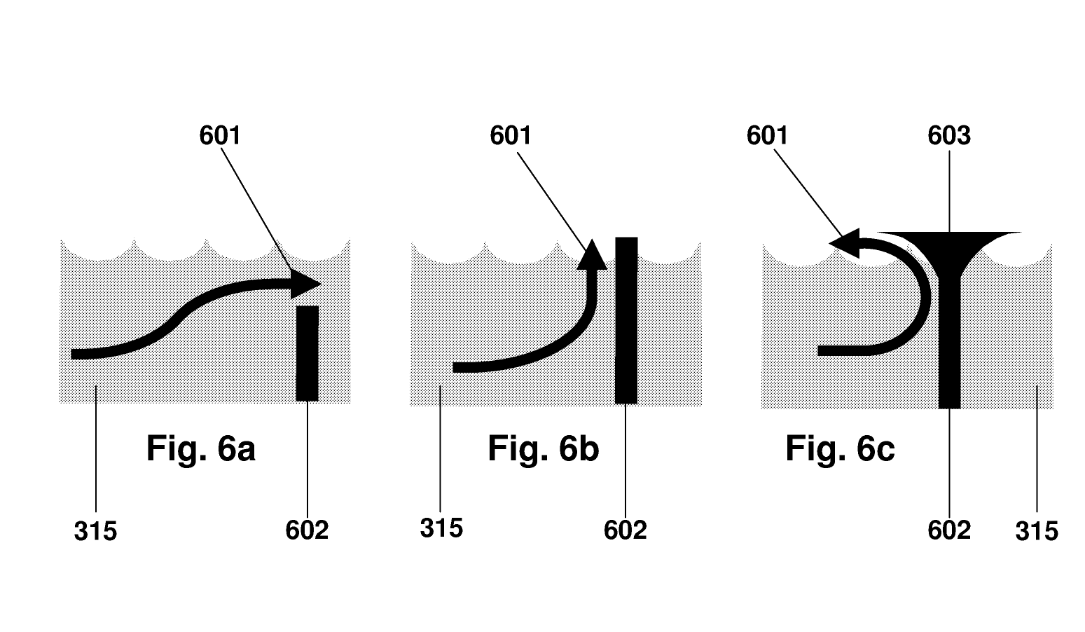

FIGS. 6a, 6b, and 6c show the interplay of escape routes and momentum transfer near the top (horizontal) edge of a surgeWEC paddle 602. As discussed above in reference to FIG. 2, power capture requires that the WEC structure, the paddle 602 in FIGS. 6a, 6b, and 6c, move relative to the water. (The paddle and the water move in the same direction, but the paddle moves more slowly, as in FIG. 2.) This relative motion displaces water in front of the paddle, and this displaced water must go somewhere. The arrows 601 in FIGS. 6a, 6b, and 6c indicate where it goes. The momentum transfer we seek from the water to the WEC structure is reflected in the direction change of the flow 601. The greater the direction change, the greater the force on the paddle. When the flow escapes without direction change, potential momentum transfer is lost.

FIG. 6a shows a surgeWEC system like that described in U.S. Pat. Pub. No. 2006/0150626, whose paddle 602 does not reach the water surface, thereby giving the water flow 601 an escape route over the top of the paddle.

FIG. 6b shows a surgeWEC system like that described in U.S. Pat. No. 7,834,474, whose paddle extends to and through the water surface, thereby creating freeboard. FIG. 6b shows the momentum-transfer benefit of depriving the flow 601 the escape route present in FIG. 6a. When the paddle occupies the full water column, as in FIG. 6b, the displaced water flows upward along the face of the paddle in a phenomenon called “run up”.

FIG. 6c shows the additional momentum-transfer benefit of guiding the flow into the reverse direction using a smooth concave guiding surface 603. FIG. 6c also shows the benefit of guiding the flow displaced by the paddle 602 into the space above the water surface, that is, into a space not already occupied by water. The concave structure 603 thereby achieves the desired flow reversal, and the concomitant additional force on the paddle 602.

U.S. Pat. No. 7,834,474 discloses surgeWEC top-edge terminations possessing “T”, “Y”, and “L” shapes. These are terminations of a bottom-hinged paddle possessing freeboard, in contrast to the floating structures considered here, and therefore do not have a fixed relationship to the water surface. The terminations are above the freeboard and are removed from the water surface for most of the paddle stroke. They are designed to reduce overtopping, the escape of the flow over the top of the paddle, as the paddle top rotates toward the water surface near the ends of its stroke. That is, because the paddle rotates about a sea-bed hinge, any freeboard it possesses in the middle of its stroke decreases as the paddle top rotates toward the water surface. The paddle-top terminations are thus not designed to and do not produce the flow reversal we seek.

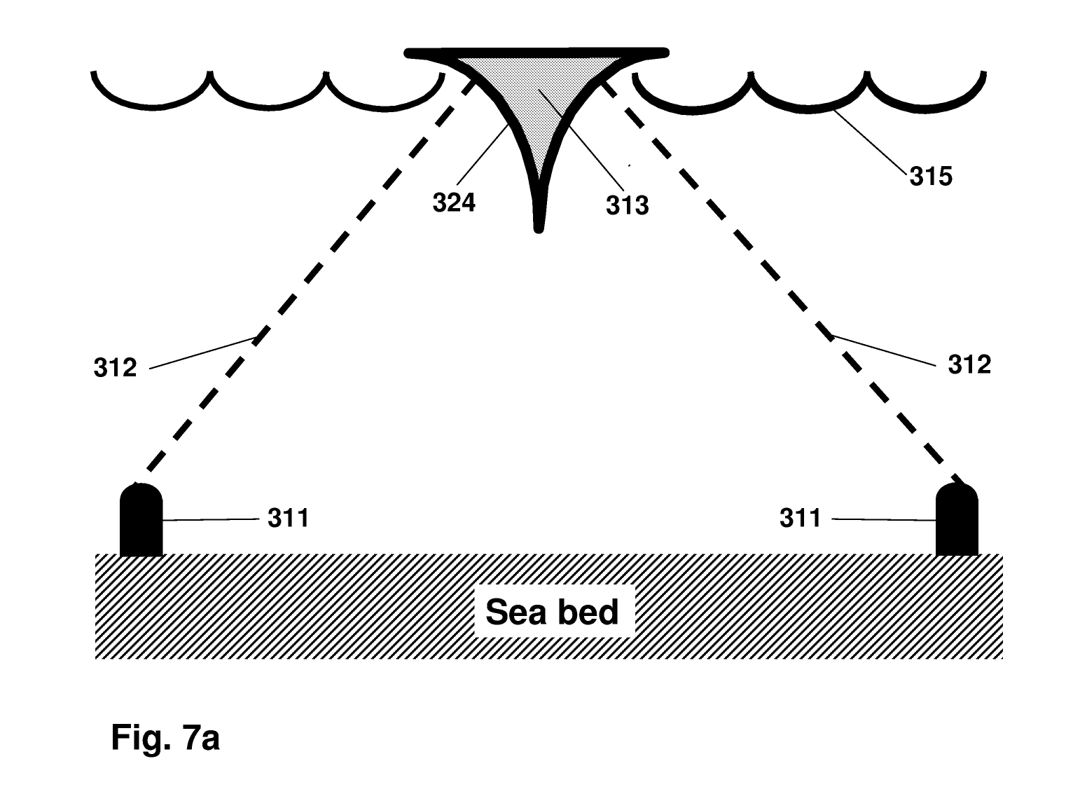

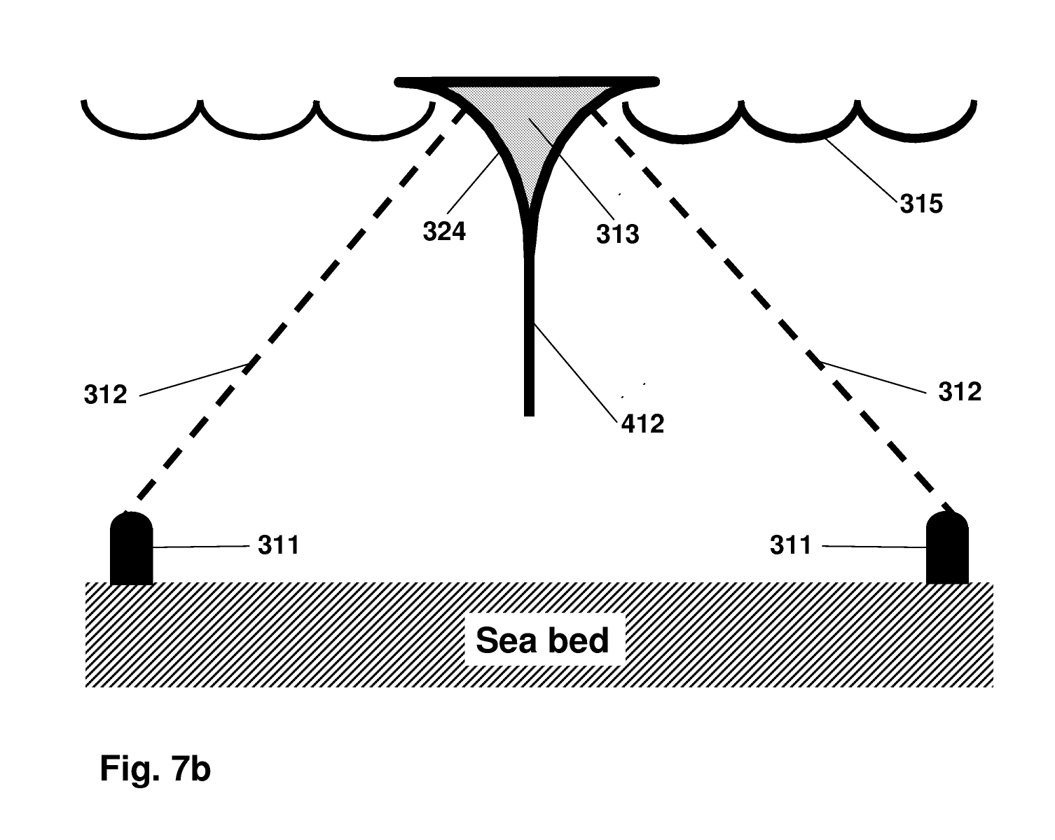

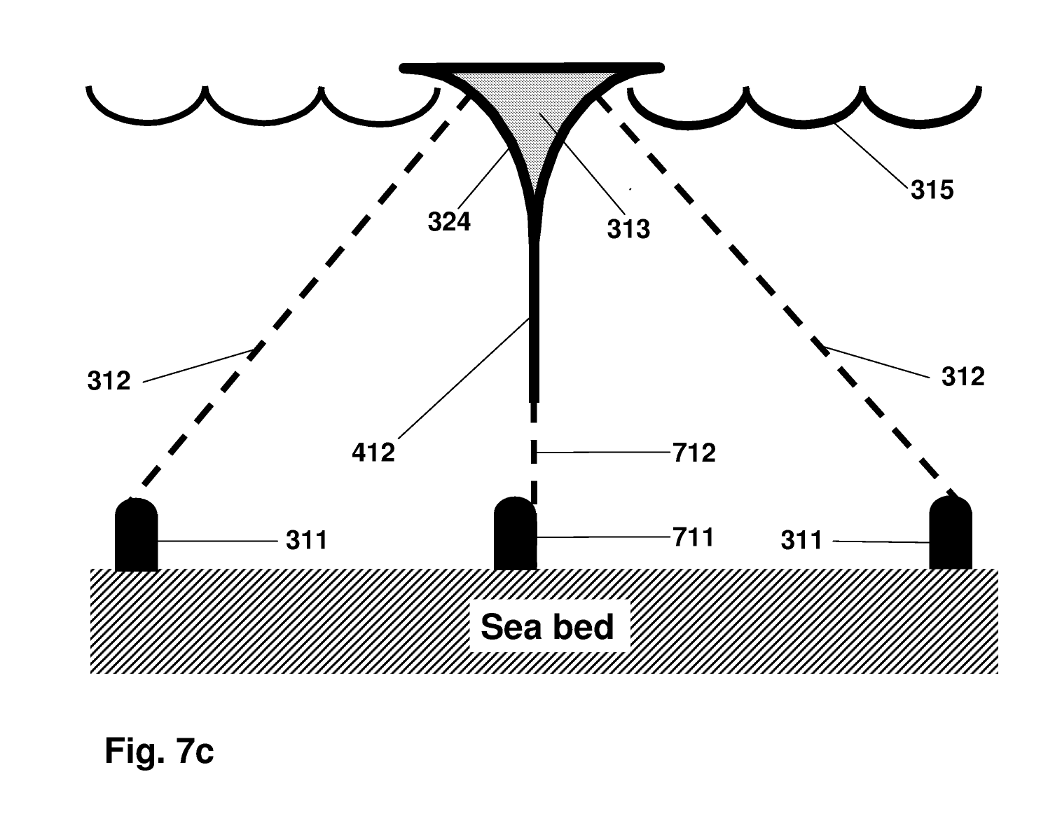

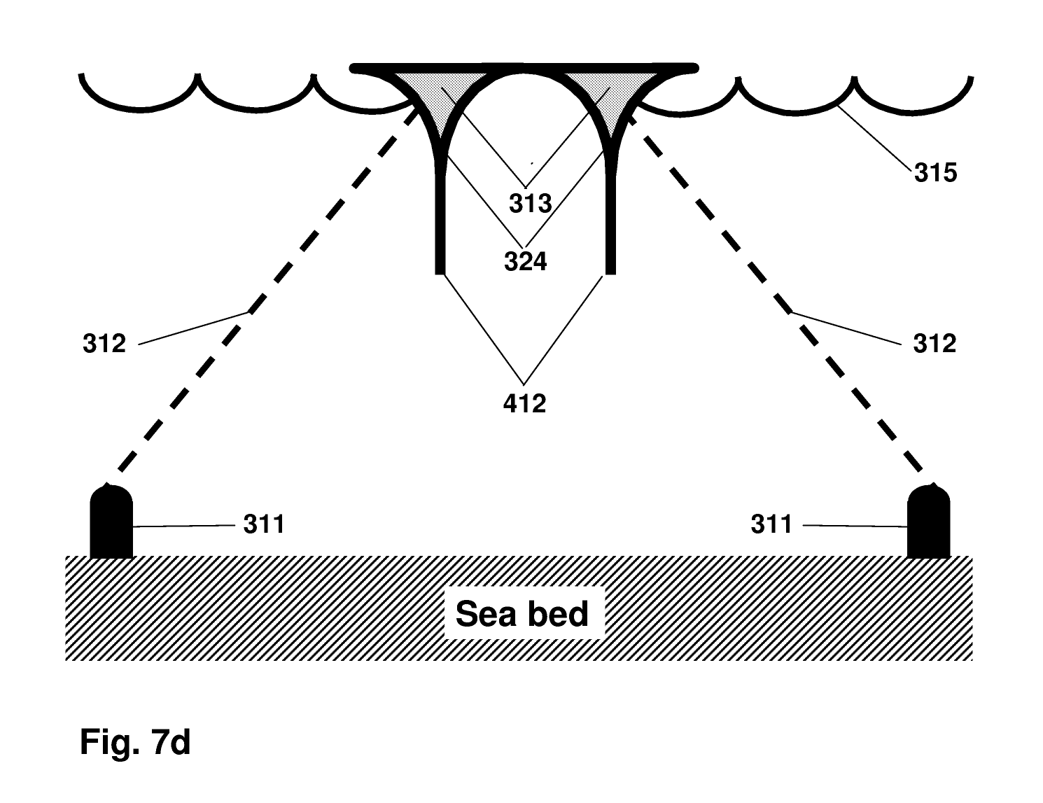

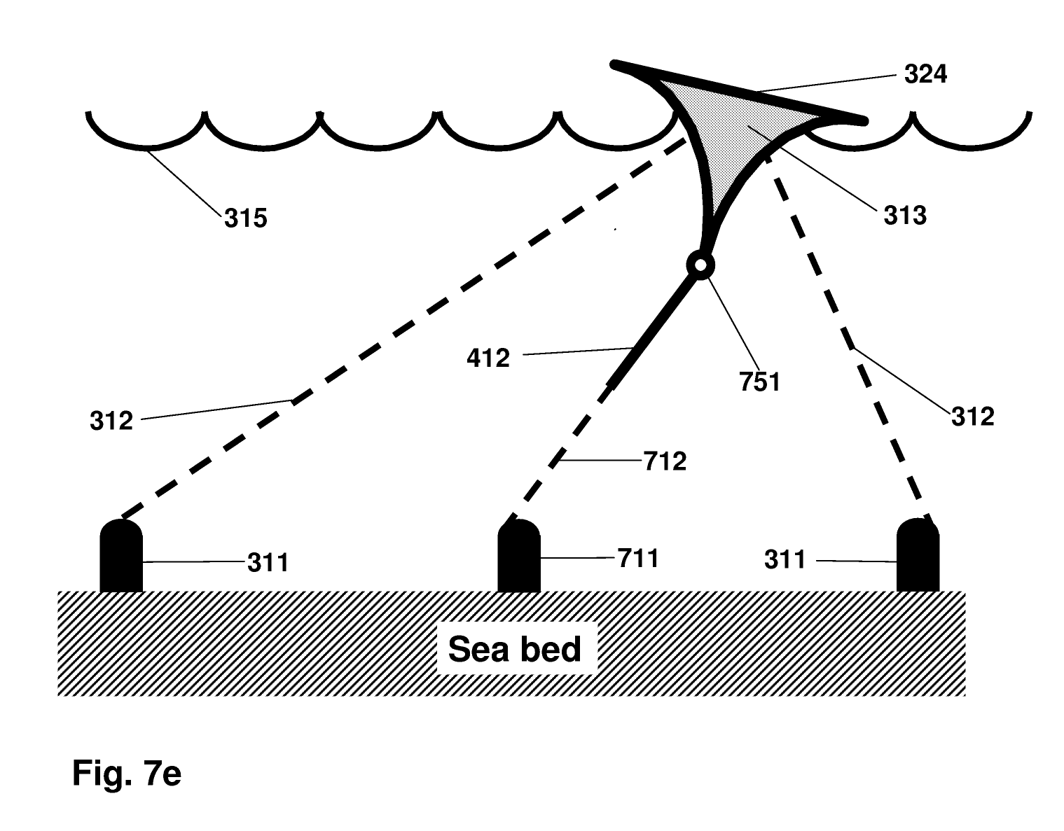

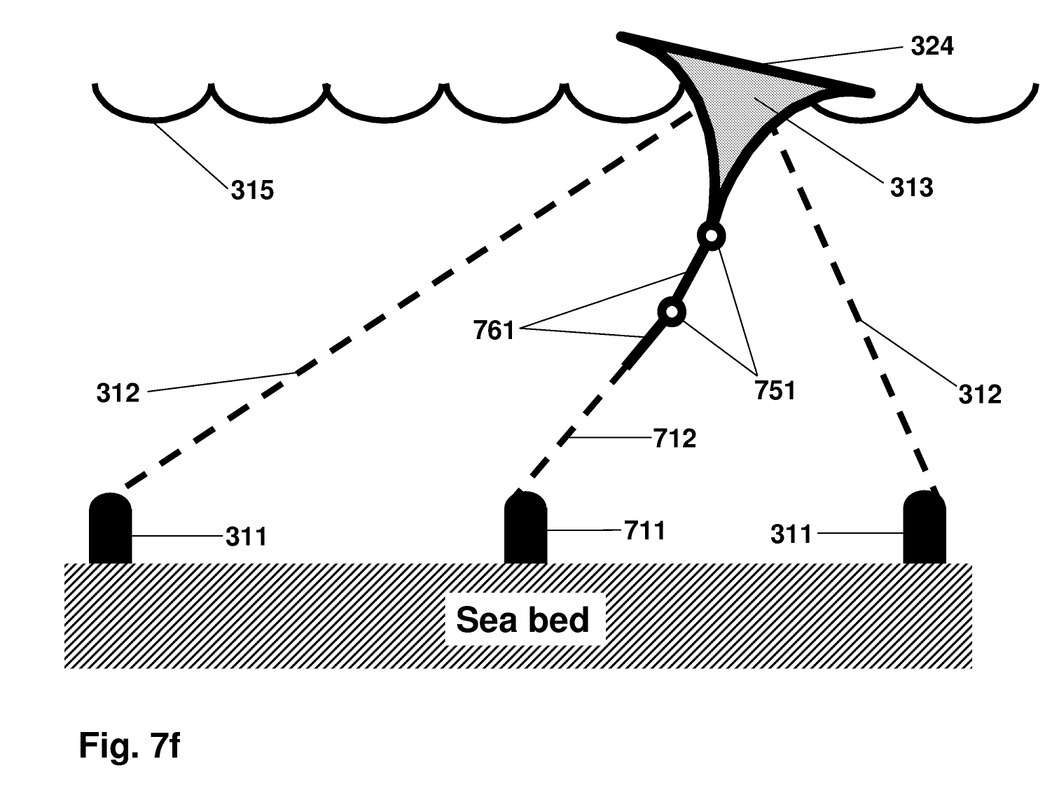

A WEC structure oscillates with the oscillatory motion of the local water, but with smaller amplitude. The power we capture from the wave motion is the product of the WEC motion and the force on the WEC structure by the PTO subsystem. The power-take-off (PTO) subsystem of a WEC converts this force-motion product into a more useful form of power, such as electricity. A cable connecting the moving WEC structure (the bobbing point absorber or the swaying surgeWEC paddle, for example) to an electric generator is a common PTO configuration. (The cable is wound around a drum axially attached to a generator which produces electric power when the WEC structure moves away from the drum and generator. U.S. Pat. No. 4,208,877 illustrates this configuration.) A floating WEC structure can be moored to the sea bed diagonally, thereby capturing the power contained in both the vertical (heave) and horizontal (surge) wave-induced motion of the WEC structure. U.S. Pat. No. 4,208,877 describes such a configuration. FIG. 7a also illustrates this configuration.

FIG. 7a also illustrates the replacement of the submerged cylindrical buoy described in U.S. Pat. No. 4,208,877 by a floating concave line-like structure. FIG. 7b introduces the keel, a nominally vertical extension of the buoy that increases the surface area exposed to the wave action. Without a change in the mooring shown in FIGS. 7a and 7b, the addition the force on the keel may not be captured. This brings us to the “three-point” mooring.

The additional cable-based PTO 711-712 shown in FIG. 7c serves not only to capture more of the available power; it also greatly reduces the need for structural strength in the WEC structure. The additional cable-based PTO attached to the keel allows the WEC structure to provide only tensile strength, and tensile strength is usually relatively inexpensive.

FIG. 7d illustrates the introduction of multiple hulls. Configurations like that in FIG. 7d are especially effective in capturing the heave (vertical) component of wave action.

One way to exploit the tension-only WEC structure is to attach the keel portion 512 of the structure to the buoy portion 324 by a hinge 751. This enables the WEC structure to more smoothly guide the vertical fluid flow to the concave top portion which guides the flow to the reverse direction, completing the flow reversal.

FIG. 7f shows that the keel can be subdivided into multiple panels 761 to render the flow guide even smoother.

Hinges in the keel and multiple keel panels can be taken a step further by constructing the keel from flexible fabric. A WEC keel requires great tensile strength such as that provided by the materials used in industrial conveyor belts or automobile tires. The reduction of construction costs offered by fabric keels can be substantial.

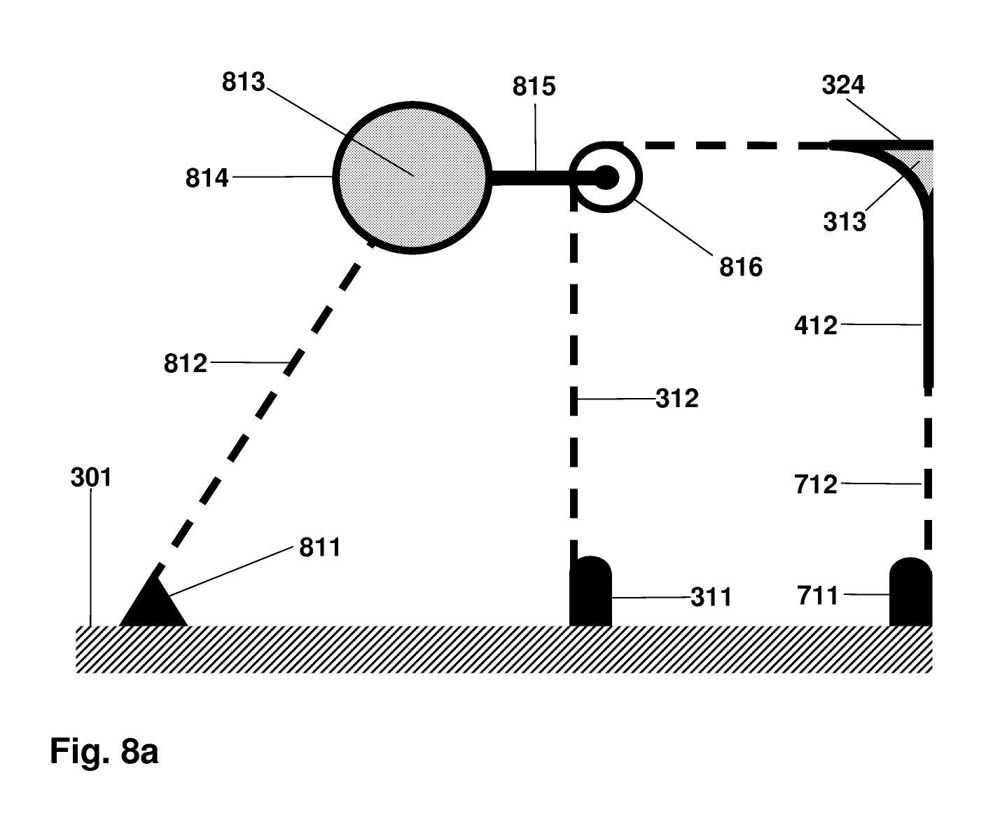

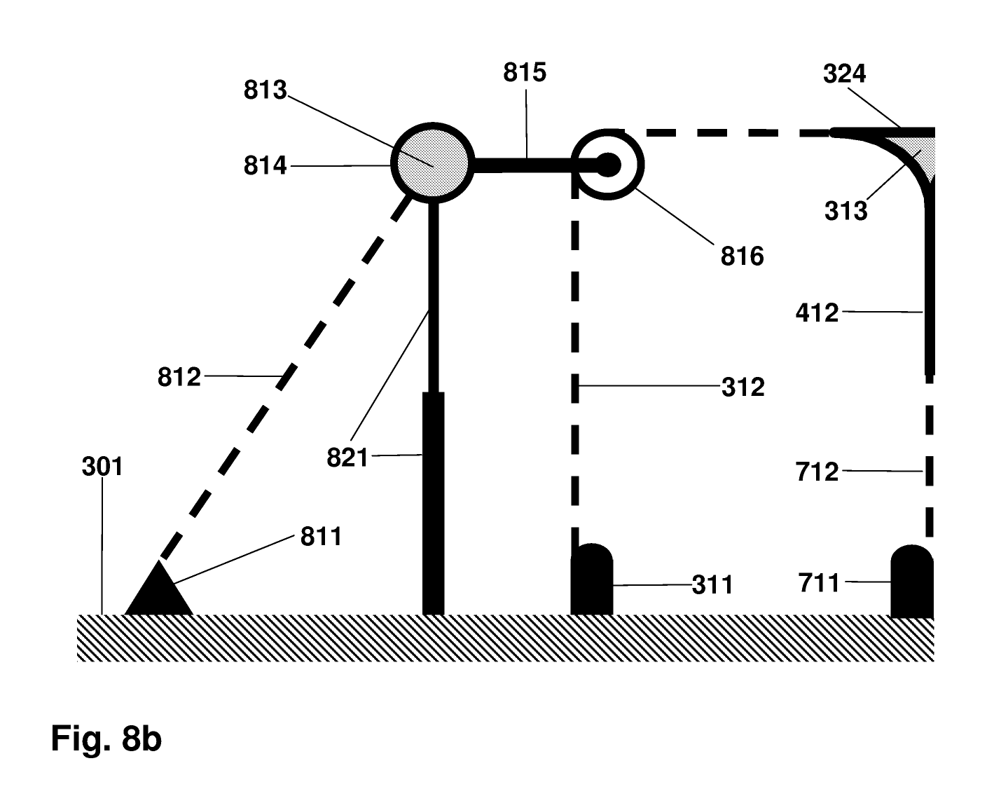

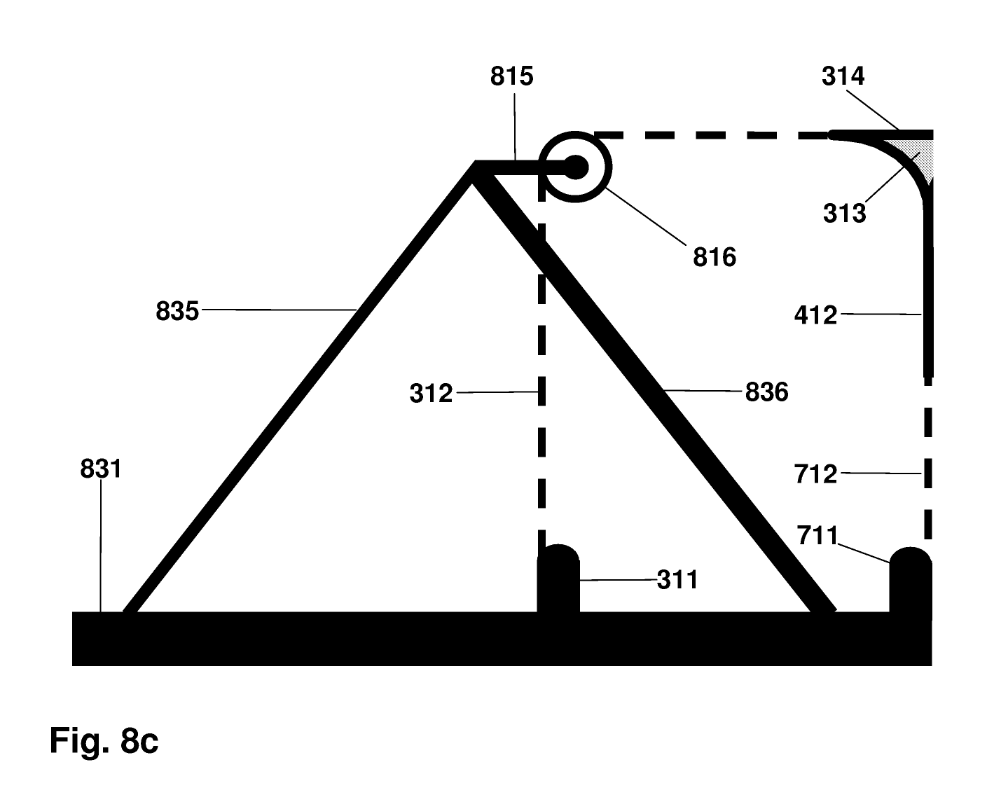

As mentioned, the power captured is the product of the force on the WEC structure and its motion. Both are vector quantities, and a cable captures only the component of both the force and the motion in the direction of the cable. Thus, a greater fraction of the power captured by the WEC structure can be converted if two substantially perpendicular cables are used to capture the circular (or elliptical) local motion of the water. In FIG. 8a, the second member of the nominally perpendicular PTO pair is provided by passing the PTO cable over a pulley 816. The pulley allows the PTO to capture the entire surge component of the wave action, leaving it to the second member of the pair, the keel attached PTO 711, 712, to capture the heave component.

One aspect of this “horizontal PTO” idea is to maintain the pulley near the height of the top of the WEC structure 324. FIGS. 8a, 8b, and 8c describe three possible approaches. Note that FIGS. 8a, 8b, and 8c show a cross section of the WEC system in which slightly more than half the system is shown. That is, just enough more than half to include the vertical cable-based PTO subsystem 711, 712. In FIG. 8a, the desired position of the pulley is maintained by a buoyant float or buoy 813, 814, 815. The horizontal position of the buoy 814 is maintained by mooring the buoy to the sea bed. As shown in FIG. 8a, the buoy 814 is attached to a winch 811 on the sea bed by a cable 812. The winch allows the buoy 811 height to track tidal depth variations, but it is not a PTO.

FIG. 8b shows that the size of the buoy 815 can be reduced by supplementing the buoyancy of the buoy 815 with direct piston support 821 from the sea bed. In the configuration shown in FIG. 8b, the buoy 811 tracks tidal depth variations by the coordinated action of the winch 815 and the piston 821. If the WEC structure is moored to a floating platform, then the role of tidal tracking can be performed by the platform, and the position of the buoy 811 can be maintained by a structure 814, 816 mounted on the platform 831, as shown in FIG. 8c.

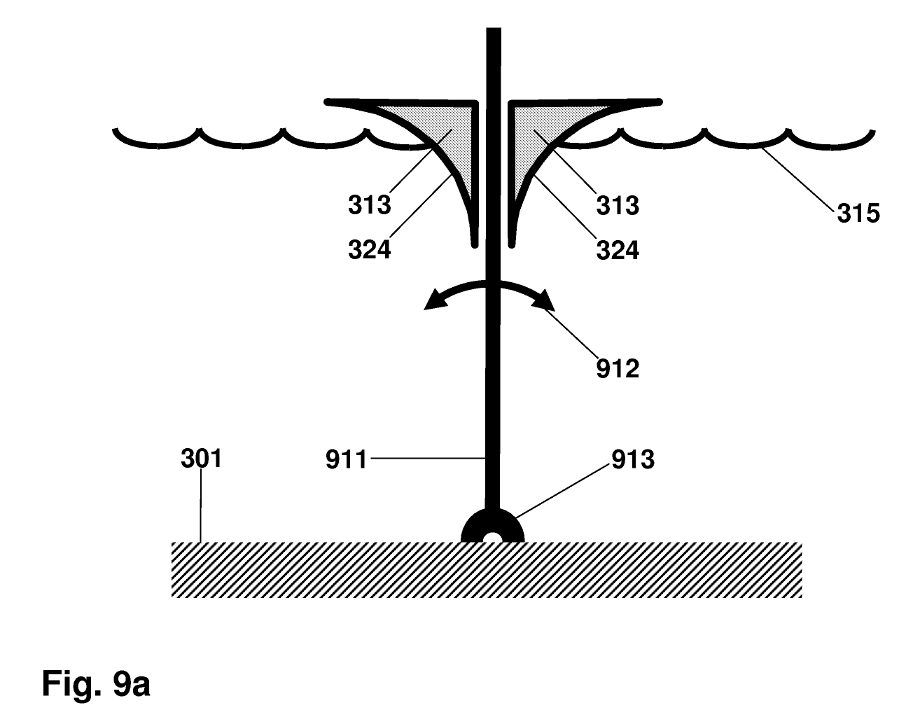

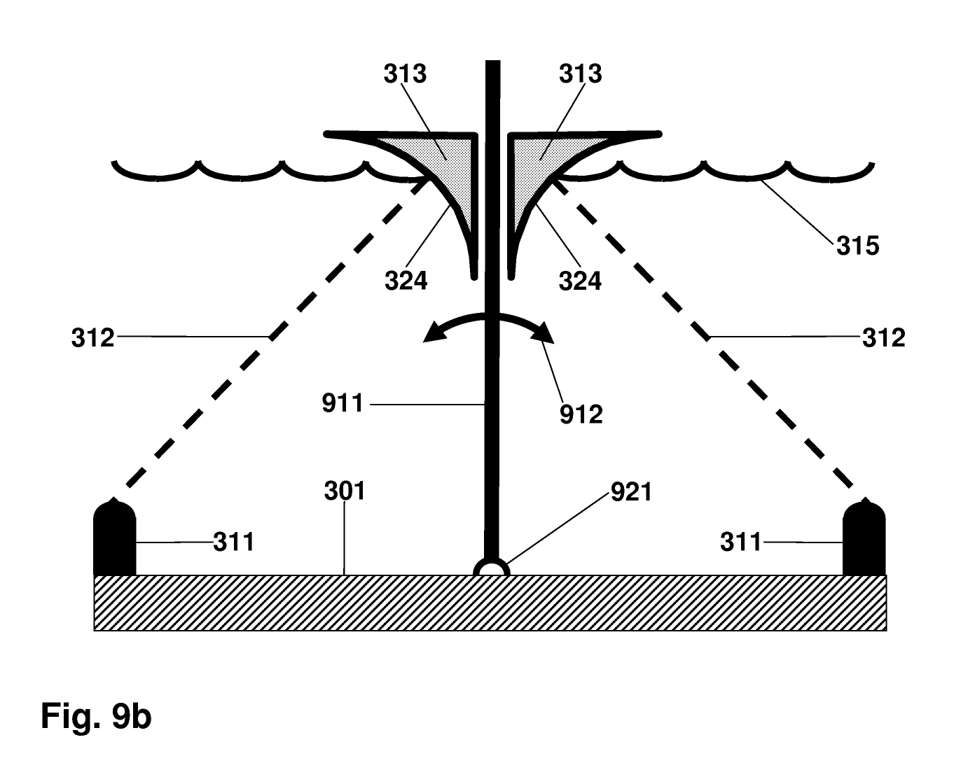

Hinged surgeWEC systems such as the WaveRoller™ and the Oyster™ systems have been developed. FIG. 9 indicates how concavity might be exploited by such devices. As shown in FIG. 9, a hinged surgeWEC system whose paddle 911 extends to and through the water surface 315 is complemented by a buoy 324 that straddles the paddle 911 riding up and down on the paddle 911. Not shown in FIG. 9 is the connection between the two halves of the buoy 324 outside the two vertical edges of the paddle. The buoy 324 is a structure enclosing the paddle 911.

FIGS. 9a and 9b differ in the type of PTO they use to convert the power captured by the WEC structure. The system shown in FIG. 9a uses the hinge 913 as the PTO. A vane pump axially mounted on the hinge 913 axis, for example, may be used to convert the power captured by the paddle into pressurized fluid, for example. FIG. 9b employs the same type of cable-based PTO used in the other embodiments considered here. In the system shown in FIG. 9b, the paddle is mounted to the base by a hinge 921, and pairs of cable-based PTO subsystems convert the captured power.

FIG. 9 illustrates that, because cables can transmit only tension, two cable-based PTO subsystems are required to perform the same function as a single PTO of another type, such as the hinge-based system shown in FIG. 9a.

A WEC structure can be PTO moored to the sea bed or to a platform. We can refer to either as the “base”. U.S. Pat. Pub. No. 2010/0111609 describes a platform-mounted surgeWEC system, and European Pat. Appl. No. 2128430 illustrates a platform mounted point absorber.

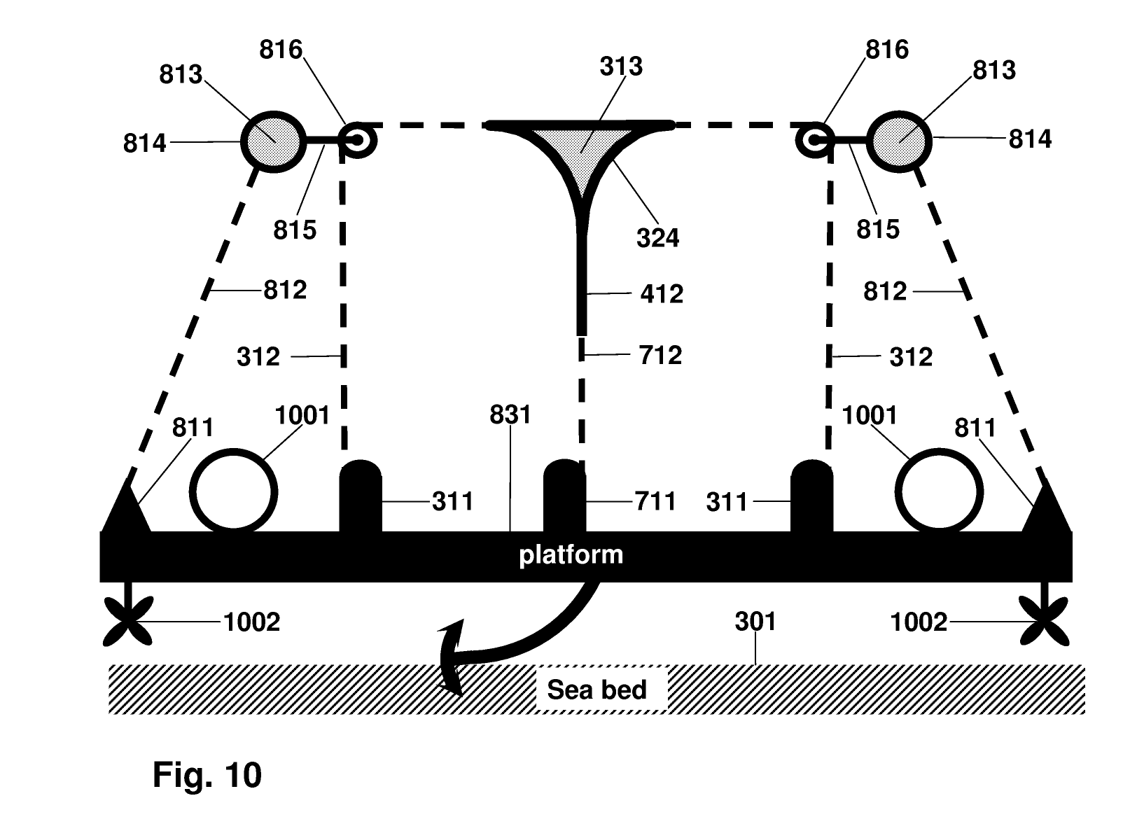

One distinction between sea-bed and platform WEC mounting is tide tracking. Tidal variations in depth are comparable to and often greater than wave amplitudes and wave amplitudes set the scale for the amplitude of the local water oscillatory motion underlying wave action. In this regard, platform mounting offers several advantages, starting with tide tracking and including wave-direction tracking, the facilitation of maintenance, and a natural way of protecting the WEC system in violent weather. The depth at which the system is positioned relative to the water surface may be controlled by floatation, that is, ballast tanks may be filled and evacuated as done with marine vessels, submarines in particular. Platforms can also be rotated so as to maintain a desired orientation with regard to wind and wave direction. A platform-mounted system is depicted in FIG. 10. Note that a sea-bed mounted system can be protected from violent weather by pulling the floating components below the water surface.

Because individual point-like WEC structures expose relatively small areas to the wave action, such systems can be deployed in replicated arrays. An advantage of such array deployment is the opportunity it provides for averaging and thereby smoothing (reducing the fluctuations) in the power produced by individual point absorbers. A second benefit of replicated arrays is the opportunity to share resources, such as PTO moorings.

A surgeWEC system, that is, a WEC that extends to an arbitrary length in the direction of the wave crest (usually parallel to the shoreline), is typically not a candidate for replication. If a surgeWEC system removes a substantial fraction the energy carried by an incident wave, there is generally little motivation to position surgeWEC systems in series, that is, one behind another. SurgeWEC systems can, however, be deployed end-to-end, forming a chain.

The power produced by the WEC PTO subsystem often fluctuates inconveniently. Thus, it can be useful to have WEC output power consumed by a process that stores the energy for later use while being substantially unaffected by such fluctuations. Hydrogen production by electrolysis is an example of such a process. Energy stored as hydrogen for later consumption also facilitates the transport of WEC power output to shore and beyond.

FIG. 10 depicts a 2D buoy 324 and 313 with a keel 412. The PTO subsystem comprises sets of three cable-based electric generators and a keel providing primarily tensile strength. Platform mooring provides tide and wave-direction tracking and facilitated maintenance as well as protection of the entire system in the face of violent weather. Note that while some of the components of the system shown in FIG. 10 extend into the plane of the diagram, others are discrete, and can be replicated as required for structural strength and capacity, phase coherence along the wave and the mechanism chosen to transport to shore the power captured by the WEC system. The concave buoy 313 and 324 extends in the direction perpendicular to the plane of the diagram. The PTO subsystem, including the generators 311 and 711 and the cables 312 and 712 and the pulley moorings 811 and 812 are all discrete. They can be replicated as frequently in the direction perpendicular to the diagram as dictated by other issues. Illustrated in FIG. 10 are ballast or floatation tanks 1001 that enable management of the depth at which the WEC system floats and a propulsion system 1002 that enables rotation of the platform about a vertical axis. Depth management enables both tide tracking and storm protection, and facilitates maintenance.

It will be appreciated by those skilled in the art that modifications to and variations of the above-described systems and methods may be made without departing from the inventive concepts disclosed herein. Accordingly, the disclosure should not be viewed as limited except as by the scope and spirit of the appended claims.

What is claimed is:

1. A wave-energy-conversion (WEC) device comprising:
a WEC structure including a substantially stationary base, and at least one concave surface,
wherein the WEC structure is at least partially immersed in a body of water and oscillates with the local water motion comprising wave action near the surface of said body of water,
wherein the amplitude of the oscillation of the WEC structure is reduced relative to that of said wave action by a restraining force provided by a power-takeoff (PTO) subsystem that combines said restraining force with oscillatory motion of said WEC structure relative to the substantially stationary base to produce power in a convenient form, and
wherein the at least one concave surface of said WEC structure faces and opposes said local water motion, tending to reverse said local water motion.

2. A wave-energy-conversion device as in claim 1 wherein said WEC structure is partially submerged and partially out of the water, providing an escape route for water displaced by said motion of said WEC structure that is both above the water surface and substantially opposite the direction of said water flow.

3. A wave-energy-conversion device as in claim 1 wherein said WEC structure is completely submerged.

4. A wave-energy-conversion device as in claim 1 wherein the size of said WEC structure is substantially comparable in all three dimensions.

5. A wave-energy-conversion device as in claim 4 wherein the at least one concave surface comprises three concave surfaces, each tethered by a cable-based PTO subsystem and clustered in a substantially tetrahedral configuration, and
wherein said three concave surfaces are joined at the water surface at the top of said tetrahedron and moored by a tripod of cable-based PTO subsystems to a triangle comprising a base of said tetrahedron.

6. A wave-energy-conversion device as in claim 5 wherein the heave component of said wave action is captured directly by a fourth cable-based PTO subsystem that connects said three concave surfaces joined at the top of said tetrahedron substantially vertically to a position near the center of the base of said tetrahedron.

7. A wave-energy-conversion device as in claim 4 wherein said WEC structure comprises a substantially circular keel extending substantially downward from the substantially horizontal perimeter of said WEC structure.

8. A wave-energy-conversion device as in claim 4 wherein said device is replicated to form a two-dimensional array of substantially identical systems, except for the phase of their oscillation.

9. A wave-energy-conversion system as in claim 1 wherein the size of said WEC structure in one of its three dimensions is significantly larger than its size in the other two dimensions.

10. A wave-energy-conversion system as in claim 9 wherein the long dimension of said WEC structure is oriented substantially horizontally.

11. A wave-energy-conversion system as in claim 10 wherein said WEC structure is moored by at least two pairs of cable-based PTO subsystems extending diagonally downward from said WEC structure, and
wherein the cables of each pair are substantially perpendicular so as to capture the vertical heave component of said wave action and both directions of the horizontal surge component of said wave action.

12. A wave-energy-conversion system as in claim 11 wherein a third cable-based PTO subsystem is added to each said pair of PTO subsystems, and
wherein said third PTO subsystem extends substantially vertically downward so as to capture the heave component of said wave action directly.

13. A wave-energy-conversion system as in claim 9 wherein said long dimension of said WEC structure is substantially vertical.

14. A wave-energy-conversion system as in claim 13 wherein said WEC structure comprises of a triangular cluster of three individually concave substructures,
wherein each said concave substructure is individually moored to the base by a cable-based PTO subsystem, the said cable-based PTO subsystems substantially forming a tetrahedral tripod and
wherein a fourth cable-based PTO subsystem moors the bottom of said vertical long dimension of said WEC structure cluster substantially vertically to a point near the center of the triangle form by said tripod of cable-based PTO subsystems.

15. A wave-energy-conversion system as in claim 1 wherein the size of said WEC structure in one of its three dimensions is significantly smaller than its size in the other two dimensions, and
wherein said concavity near the vertical edges of said WEC structure resist the escape of said local water motion around said vertical edges of said WEC structure.

16. A wave-energy-conversion (WEC) system comprising:
a WEC structure that floats, only partially immersed, in a body of water and oscillates with the local water motion comprising wave action near the surface of said body of water,
wherein the amplitude of said oscillation is reduced relative to that of said wave action by a restraining force provided by a power-takeoff (PTO) subsystem that combines said restraining force with said oscillatory motion of said WEC structure to produce power in a convenient form, and
wherein said WEC structure comprises a keel component, and a floating-buoy component, the keel component being attached to and descending from the floating-buoy component, thereby increasing the area of the WEC structure confronting the wave action.

17. A wave-energy-conversion system as in claim 16 wherein said WEC structure is moored by at least two sets of three cable-based PTO subsystems,
wherein two of each said set of three cable-based PTO systems extend away from said buoy sufficiently horizontally as to capture both directions of the surge component of said wave action, and the third cable-based PTO subsystem of each said set of three cable-based PTO subsystems extends substantially vertically downward from the bottom of said keel.

18. A wave-energy-conversion system as in claim 17 wherein said keel component of said WEC structure is hinge attached to said buoy component of said WEC structure.

19. A wave-energy-conversion system as in claim 18 wherein said keel component of said WEC structure comprises at least two horizontal panels, hinge attached to one another.

20. A wave-energy-conversion system as in claim 17 wherein said keel component of said WEC structure is made of a flexible fabric.

21. A wave-energy-conversion (WEC) system comprising:
a WEC structure that floats, only partially immersed, in a body of water and oscillates with the local water motion comprising wave action near the surface of said body of water,
wherein the amplitude of said oscillation is reduced relative to that of said wave action by a restraining force provided by a power-takeoff (PTO) subsystem that combines said restraining force with said oscillatory motion of said WEC structure to produce power in a convenient form, and
wherein said WEC structure comprises at least two keel components and a floating buoy component, the keel components being attached to and descending from the floating buoy component, thereby increasing the area of the WEC structure confronting the wave action and presenting a strongly concave surface to the heave (vertical) component of said wave action.

22. A wave-energy-conversion system as in any one of claim 9, 15 or 16 wherein said system is replicated to form a string of substantially identical systems, except for the phase of their oscillation.

23. A wave-energy-conversion (WEC) system comprising:
a WEC structure at least partially submerged in a body of water that oscillates with the local water motion comprising wave action near the surface of said body of water,
wherein the amplitude of oscillations are reduced relative to that of said wave action by a restraining force provided by a power-takeoff (PTO) subsystem that combines said restraining force with said oscillatory motion of said WEC structure to produce power in a convenient form,
wherein said WEC structure comprises a substantially planar paddle that is attached to a base by a hinge-based PTO subsystem, and a second component that surrounds said paddle and moves radially along said paddle and is shaped to provide a concave surface that guides water moving upward along the surface of said paddle into the direction opposite that of both said paddle and said local wave action.

24. A wave-energy-conversion (WEC) system comprising:
a WEC structure at least partially submerged in a body of water that oscillates with the local water motion comprising wave action near the surface of said body of water,
wherein the amplitude of oscillations are reduced relative to that of said wave action by a restraining force provided by a power-takeoff (PTO) subsystem that combines said restraining force with said oscillatory motion of said WEC structure to produce power in a convenient form,
wherein said WEC structure comprises a substantially planar paddle that is hinge attached to a base, and a second component that surrounds said paddle and moves radially along said paddle and is shaped to provide a concave surface that guides water moving upward along the surface of said paddle into the direction opposite that of both said paddle and said local wave action, and
wherein said second component is moored to said base by at least two pairs of substantially perpendicular cable-based PTO subsystems.

25. A cable-based PTO subsystem of a WEC structure, comprising:
a cable, a pulley, and a buoyant buoy, the pulley being operative to change the direction of motion of said cable from substantially horizontal near the WEC structure to substantially vertical near a base to which said WEC structure is moored, and
wherein said pulley is held in a position near the surface of the water in which said WEC structure operates by the buoyant buoy moored diagonally to the base of said WEC structure.

26. A cable-based PTO subsystem of a WEC system, comprising:
a first cable, a second diagonal cable, a pulley, a buoyant buoy, and a hydraulic piston, the pulley being operative to change the direction of motion of said first cable from substantially horizontal near the WEC system to substantially vertical near a base to which said WEC system is moored, and
wherein said pulley is held in a position near the surface of the water in which said WEC system operates by the hydraulic piston connecting said buoyant buoy to said base and by the second diagonal cable mooring to said base.

27. A cable-based PTO subsystem of a platform-moored WEC system, comprising:
a cable, and a pulley operative to change the direction of motion of said cable from substantially horizontal near the WEC system to substantially vertical near a base to which said WEC system is moored, and
wherein said pulley is held in a position near the surface of the water in which said WEC system operates by a structure attached to said platform.

28. A wave-energy-conversion (WEC) system, comprising:
a WEC structure that is at least partially immersed in a body of water and oscillates with the local water motion comprising wave action near the surface of said body of water,
wherein the amplitude of said oscillation is reduced relative to that of said wave action by a restraining force provided by a power-takeoff (PTO) subsystem that combines said restraining force with said oscillation of said WEC structure to produce power in a convenient form,
wherein the said WEC structure moves relative to a substantially stationary base,
wherein said base is a floating platform that floats at a depth where the local water motion due to surface wave action is small, and
wherein the depth at which the platform floats is controlled by the filling and evacuation of ballast tanks.

29. A wave-energy-conversion (WEC) system comprising:
a WEC structure that is at least partially immersed in a body of water and oscillates with the local water motion comprising wave action near the surface of said body of water,
wherein the amplitude of said oscillation is reduced relative to that of said wave action by a restraining force provided by a power-takeoff (PTO) subsystem that combines said restraining force with said oscillatory motion of said WEC structure to produce power in a convenient form,
wherein the said WEC structure moves relative to a substantially stationary base,
wherein said base is a floating platform that floats at a depth where the local water motion due to surface wave action is small, and
wherein a propulsion system is attached to said platform that is capable of rotating said platform about a vertical axis.

30. A wave-energy-conversion (WEC) system comprising:
a WEC structure that is at least partially immersed in a body of water and oscillates with the local water motion comprising wave action near the surface of said body of water,
wherein the amplitude of said oscillation is reduced relative to that of said wave action by a restraining force provided by a power-takeoff (PTO) subsystem that combines said restraining force with said oscillation of said WEC structure to produce power in a convenient form,
wherein the said WEC structure moves relative to a substantially stationary base,
wherein said PTO subsystem produces electric power that is consumed by a process,
wherein said process stores energy, and
wherein said process is substantially unaffected by fluctuations in the power captured by the WEC.

31. A method of capturing and converting the energy contained in waves propagating at the surface of a body of water comprising the steps of:
providing a wave-energy-conversion (WEC) system comprising a WEC structure that is at least partially immersed in a body of water and oscillates with the local water motion comprising wave action near the surface of said body of water,
wherein the amplitude of said oscillation is reduced relative to that of said wave action by a restraining force provided by a power-takeoff (PTO) subsystem that combines said restraining force with said oscillatory motion of said WEC structure relative to a substantially stationary base to produce power in a convenient form, and
wherein at least one surface of said WEC structure that faces and opposes said local water motion is concave, tending to reverse said local water motion.

32. A method of capturing and converting the energy contained in waves propagating at the surface of a body of water comprising the steps of:
providing a wave-energy-conversion (WEC) system comprising a WEC structure that floats, only partially immersed, in a body of water and oscillates with the local water motion comprising wave action near the surface of said body of water,
wherein the amplitude of said oscillation is reduced relative to that of said wave action by a restraining force provided by a power-takeoff (PTO) subsystem that combines said restraining force with said oscillatory motion of said WEC structure to produce power in a convenient form, and
wherein said WEC structure comprises two components, a keel portion attached to and descending from a floating buoy component, thereby increasing the area of the WEC structure confronting the wave action.
